(19) United States
(12) Patent Application Publication
(10) Pub. No.: US 2020/0252691 A1
(43) Pub. Date: Aug. 6, 2020

(54) APPARATUS AND METHOD FOR CONCURRENT VIDEO VIEWING WITH USER-ADDED REALTIME CONTENT

(71) Applicant: THOMSON Licensing

(72) Inventors: Kent LYONS, Mountain View, CA (US); Jean C. BOLOT, Los Altos, CA (US); Caroline HANSSON, Oerebro (SE); Amit DATTA, Pittsburgh, PA (US); Snigdha PANIGRAHI, Stanford, CA (US); Rashish TANDON, Austin, TX (US); Wenling SHANG, Ann Arbor, MI (US); Naveen GOELA, Berkeley, CA (US)

(21) Appl. No.: 15/774,485

(22) PCT Filed: Nov. 10, 2015
(86) PCT No.: PCT/US2015/059975

§ 371 Date: May 8, 2018

(51) Int. Cl. H04N 21/4788; H04N 21/431; H04N 21/4725

(52) U.S. Cl. CPC H04N 21/4788; H04N 21/4725; H04N 21/4316

(57) ABSTRACT

The present principles generally relate to video processing and viewing, and particularly, to concurrent viewing of a video with other users and processing of user-added, real-time content. The present principles provide capabilities to create a shared video viewing experience which merge concurrent video watching with u user-provided real-time commenting and content. Users watching the same content at the same time may overlay graphical elements on the shared video to communicate with other concurrent viewers of the video. These graphical elements are annotations used to communicate with another viewer, or among a group of viewers, and are overlaid onto the video itself in real time during an interactive session as though the users are in concurrent conversations.

### FIELD OF THE INVENTION

The present principles generally relate to video processing and viewing, and particularly, to concurrent viewing of a video with other users and processing of user-added, real-time content.

### BACKGROUND INFORMATION

This section is intended to introduce a reader to various aspects of art, which may be related to various aspects of the present principles that are described and/or claimed below. This discussion is believed to be helpful in providing the reader with background information to facilitate a better understanding. Accordingly, it should be is understood that these statements are to be read in this light, and not as admissions of prior art.

More and more consumers are shifting from viewing televisions with traditional broadcast and cable services to watching and/or downloading Internet video via a broadband or Wi-Fi connection. The traditional broadcast and cable services do not allow an easy way for a user to interact with other viewers who are also watching the same programs, since the communication is only one way, from the broadcasters to the televisions.

More and more consumers are also sharing their videos online using websites such as YouTube™. YouTube™ allows users to post their video content to be watched by other users. YouTube™ also provides a tool to allow a video poster to provide static annotations on the video created before it is posted on the website. The annotation is static in the sense that it is permanently affixed to the posted video and the content cannot be changed dynamically in real time or at all. In addition, YouTube™'s annotation feature is not available for live streaming services provided by YouTube™. Therefore, there is no user interactivity between people watching the same video currently in real time.

### SUMMARY

The present principles recognize that people watching a video concurrently in real time at different locations may want to have a shared viewing experience with e.g., their friends or family. The present principles further recognize that in today's environment, such a feature is not readily available or a user may have to use a second screen in order to use a separate texting or messaging application to talk about the video they are watching together on the primary screen.

Accordingly, the present principles provide capabilities to create a shared video viewing experience which merge concurrent video watching with user-provided real-time commenting and content. For example, users watching the same content at the same time may overlay graphical elements on the shared video to communicate with their friends. Hence, according to the present principles, someone may put a “thumbs up” or a “smiley” sticker or emoji directly on a video scene they like. They may also put, e.g., a speech bubble on one of the characters in the video to make a joke. These sticker annotations are used to communicate with another viewer, or among a group of viewers, and are overlaid onto the video itself in real time during an interactive session as though the users are in concurrent conversations.

Accordingly, a first electronic device is presented for communicating with a second electronic device, the second electronic device being at a remote location and displaying a video, the first electronic device comprising: a display device configured to display the video concurrently with the second electronic device; a user interface device configured to select a first communication item at the first electronic device and to overlay the selected first communication item onto the video at the first electronic device, the first item being overlaid onto the video during an interactive session between the first electronic device and the second electronic device; and a processor configured to provide information on the overlaid selected first communication item for displaying the first communication item overlaid onto the video at the second electronic device.

In another exemplary embodiment, a method performed by a first electronic device is presented for communicating with a second electronic device, the second electronic device being at a remote location and displaying a video, the method comprising: displaying concurrently the video on a display device of the first electronic device; selecting a first communication item at the first electronic device; overlaying the selected first communication item onto the video at the first electronic device, the first item being overlaid onto the video during an interactive session between the first electronic device and the second electronic device; and providing information on the selected first communication item for displaying the first communication item overlaid onto the video at the second electronic device.

In another exemplary embodiment, a computer program product stored in non-transitory computer-readable storage media for a first electronic device is presented for communicating with a second electronic device, the second electronic device being at a remote location and displaying a video, comprising computer-executable instructions for: displaying concurrently the video on a display device of the first electronic device; selecting a first communication item at the first electronic device; overlaying the selected first communication item onto the video at the first electronic device, the first item being overlaid onto the video during an interactive session between the first electronic device and the second electronic device; and providing information on the selected first communication item for displaying the first communication item overlaid onto the video at the second electronic device.

### DETAILED DESCRIPTION OF THE DRAWINGS

The above-mentioned and other features and advantages of the present principles, and the manner of attaining them, will become more apparent and the invention will be better understood by reference to the following description of embodiments of the present principles taken in conjunction with the accompanying drawings, wherein:

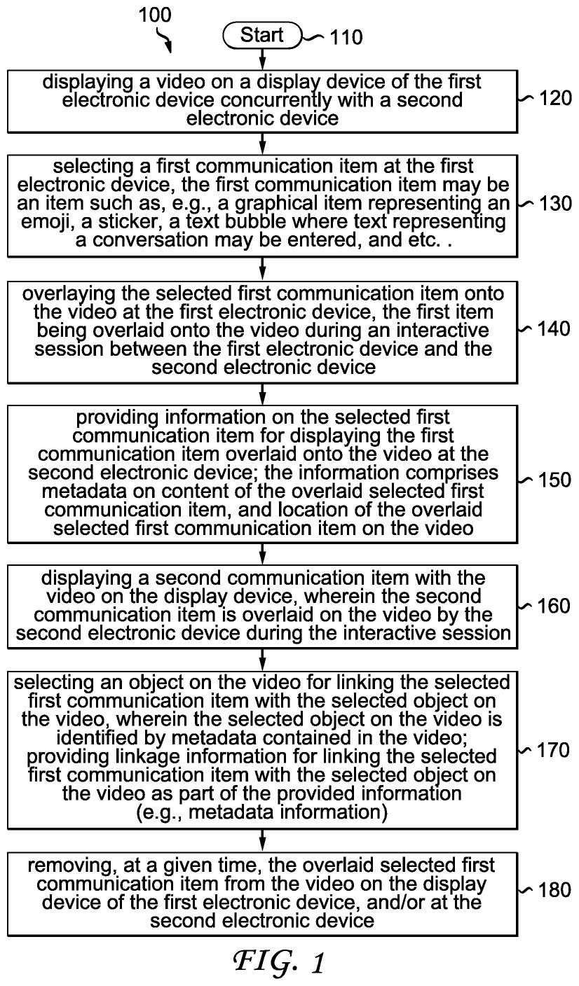

FIG. 1 shows an exemplary process according to the present principles;

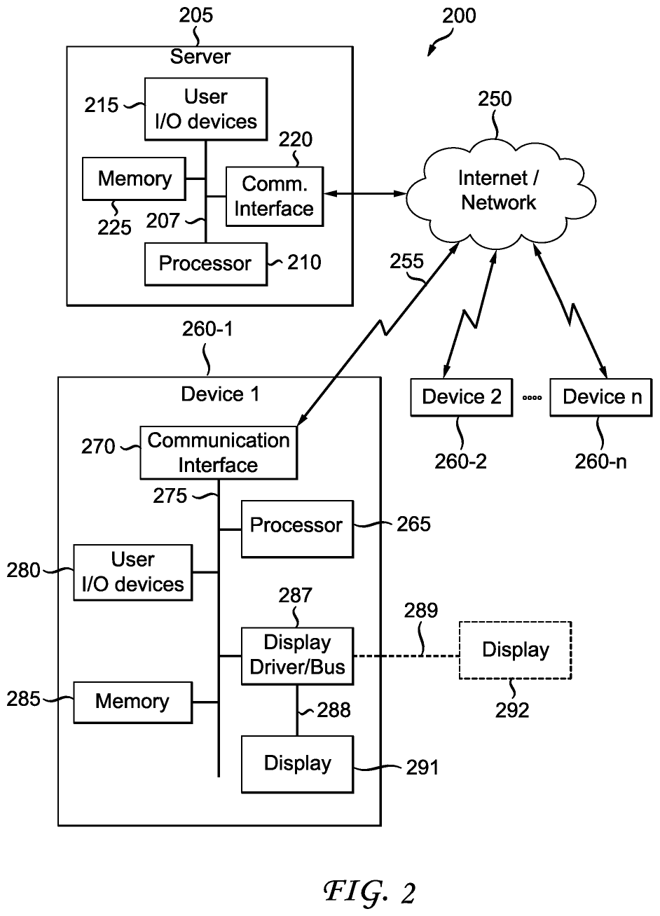

FIG. 2 shows an exemplary system according to the present principles;

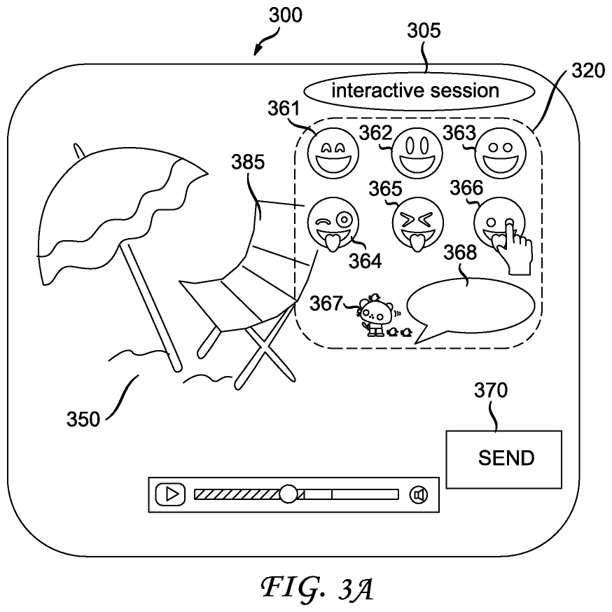

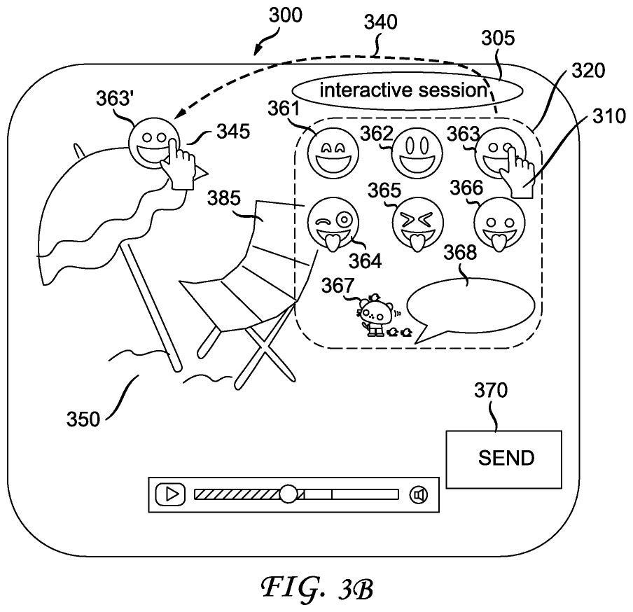

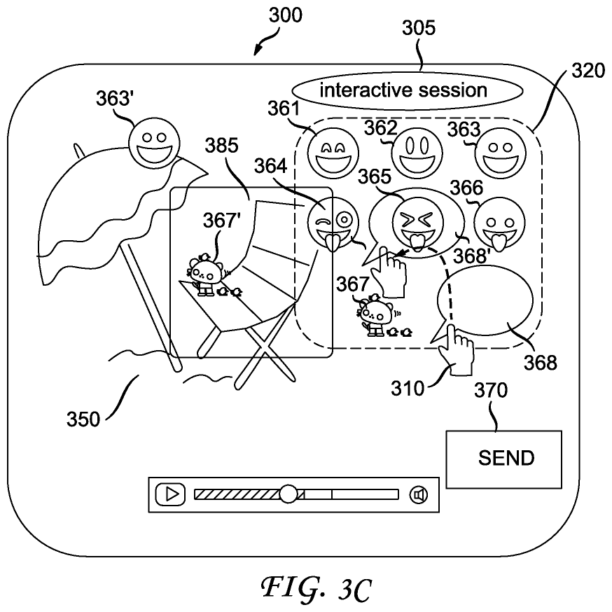

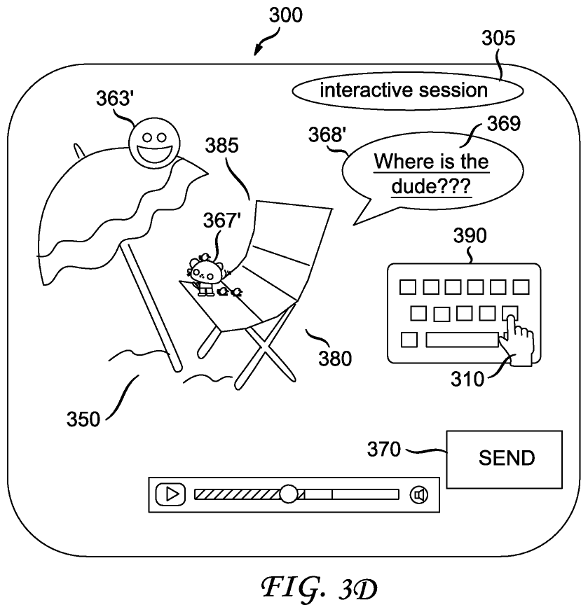

FIGS. 3A-3D show an exemplary apparatus and its user interface according to the present principles; and

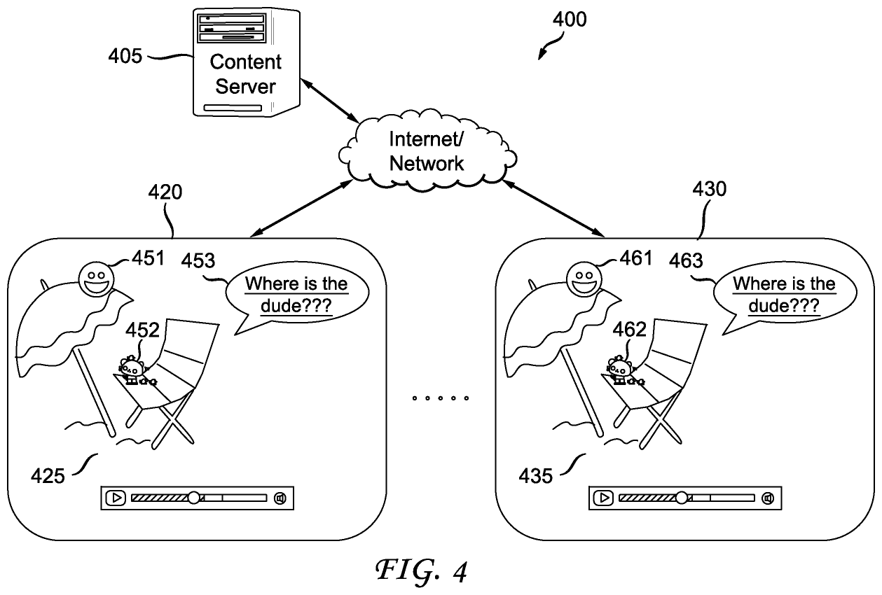

FIG. 4 also shows an exemplary system according to the present principles.

The examples set out herein illustrate exemplary embodiments of the present principles. Such examples are not to be construed as limiting the scope of the invention in any manner.

### DETAILED DESCRIPTION

The present principles allow a viewer to mix user-provided communication items including customizable graphical items such as stickers or emoji icons, or conversation texts onto a shared video in a time and spatially relevant way to provide a novel communication mechanism. While watching the same video concurrently, one user may add an item such as a sticker onto the video at a certain timestamp and in a spatial location (spatial location may mean pixel position within a video frame or specific objects such as an actor or a chair in the video that may move in a scene). The other remotely located video devices in the same interactive session of the video viewing/conversation would receive the metadata of the inserted items and render the items as needed on the video.

In one exemplary embodiment, the inserted item may persist for a given duration, or disappear once the other viewer sees it or removes it. People at the remote locations who are watching the same video concurrently may respond to an inserted item by adding another user-added item, or moving or deleting the original item. For one exemplary embodiment, there may be a predetermined set of available items for easy access for annotations—e.g., to allow a drag and drop of the user-selected items while watching the video. Accordingly, the present principles allow for a new and advantageous form of communication between concurrent video viewers and thus creating an enhanced shared viewing experience. The present principles also provide user communication onto the video itself and thus eliminate the need to have a separate chat or texting window, or a separate user device. The user-provided communication items may be used to convey in real time, emotions, feelings, thoughts, speech, and etc.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read-only memory (“ROM”) for storing software, random access memory (“RAM”), and non-volatile storage.

FIG. 1 shows an exemplary process 100 according to the present principles which will be described in detail below. The process 100 of FIG. 1 may be performed by an exemplary system 200 as shown in FIG. 2. For example, a system 200 in FIG. 2 includes a content server 205 which is capable of receiving and processing user requests from one or more of user devices 260-1 to 260-n. The content server 205, in response to the user requests, provides program contents comprising various media assets such as movies or TV shows for viewing, streaming or downloading by users using the devices 260-1 to 260-n. According to the present principles, a video content provided by the content server 205 may be streamed concurrently to multiple devices and watched by multiple users concurrently. Such content may be a live event and/or a multi-cast content selected by one or more of the exemplary devices 260-1 to 260-n in FIG. 2.

Various exemplary user devices 260-1 to 260-n in FIG. 2 may communicate with the exemplary server 205 over a communication network 250 such as the Internet, a wide area network (WAN), and/or a local area network (LAN). Server 205 may communicate with user devices 260-1 to 260-n in order to provide and/or receive relevant information such as metadata, web pages, media contents, and etc., to and/or from user devices 260-1 to 260-n. Server 205 may also provide additional processing of information and data when the processing is not available and/or capable of being conducted on the local user devices 260-1 to 260-n. As an example, server 205 may be a computer having a processor 210 such as, e.g., an Intel processor, running an appropriate operating system such as, e.g., Windows 2008 R2, Windows Server 2012 R2, Linux operating system, and etc.

User devices 260-1 to 260-n shown in FIG. 2 may be one or more of, e.g., a PC, a laptop, a tablet, a cellphone, or a video receiver. Examples of such devices is may be, e.g., a Microsoft Windows 10 computer/tablet, an Android phone/tablet, an Apple IOS phone/tablet, a television receiver, or the like. A detailed block diagram of an exemplary user device according to the present principles is illustrated in block 260-1 of FIG. 2 as Device 1 and will be further described below.

An exemplary user device 260-1 in FIG. 2 comprises a processor 265 for processing various data and for controlling various functions and components of the device 260-1, including video encoding/decoding and processing capabilities in order to play, display, and/or transport a video content. The processor 265 communicates with and controls the various functions and components of the device 260-1 via a control bus 275 as shown in FIG. 2.

Device 260-1 may also comprise a display 291 which is driven by a display driver/bus component 287 under the control of processor 265 via a display bus 288 as shown in FIG. 2. As mentioned above, the display 291 maybe a touch display. In addition, the type of the display 291 may be, e.g., LCD (Liquid Crystal Display), LED (Light Emitting Diode), OLED (Organic Light Emitting Diode), and etc. In addition, an exemplary user device 260-1 according to the present principles may have its display outside of the user device, or that an additional or a different external display may be used to display the content provided by the display driver/bus component 287. This is illustrated, e.g., by an external display 292 which is connected to an external display connection 289 of device 260-1 of FIG. 2.

In additional, exemplary device 260-1 in FIG. 2 may also comprise user input/output (I/O) devices 280. The user interface devices 280 of the exemplary device 260-1 may represent e.g., a mouse, touch screen capabilities of a display (e.g., display 291 and/or 292), a touch and/or a physical keyboard for inputting user data. The user interface devices 280 of the exemplary device 260-1 may also comprise a speaker, and/or other indicator devices, for outputting visual and/or audio user data and feedback.

Exemplary device 260-1 also comprises a memory 285 which may represent both a transitory memory such as RAM, and a non-transitory memory such as a ROM, a hard drive and/or a flash memory, for processing and storing different files and information as necessary, including computer program products and software (e.g., as represented by a flow chart diagram of FIG. 1 to be discussed below), webpages, user interface information including a plurality of user-added and/or user-selectable communication items to be described further below, metadata related to these communication items also to be described further below, databases, and etc., as needed. In addition, Device 260-1 also comprises a communication interface 270 for connecting and communicating to/from server 205 and/or other devices, via, e.g., network 250 using the link 255 representing, e.g., a connection through a cable network, a FIOS network, a Wi-Fi network, and/or a cellphone network (e.g., 3G, 4G, LTE), and etc.

User devices 260-1 to 260-n in FIG. 2 may access different media assets, web pages, services or databases provided by server 205 using, e.g., HTTP protocol. A well-known web server software application which may be run by server 205 to provide web pages is Apache HTTP Server software available from http://www.apache.org. Likewise, examples of well-known media server software applications include Adobe Media Server and Apple HTTP Live Streaming (HLS) Server. Using media server software as mentioned above and/or other open or proprietary server software, server 205 may provide media content services similar to, e.g., Amazon.com, Netflix, or M-GO. Server 205 may use a streaming protocol such as e.g., Apple HTTP Live Streaming (HLS) protocol, Adobe Real-Time Messaging Protocol (RTMP), Microsoft Silverlight Smooth Streaming Transport Protocol, and etc., to transmit various programs comprising various media assets such as, e.g., video programs, audio programs, movies, TV shows, software, games, electronic books, electronic magazines, electronic articles, and etc., to an end-user device 260-1 for purchase and/or viewing via streaming, downloading, receiving or the like. According to the present principles, user devices 260-1 to 260-n in FIG. 2 may access a video content at the same time and watch the video concurrently at different locations. The user devices 260-1 to 260-n may also process user provided overlaid items according to their corresponding metadata as to be described further below.

Video content being concurrently accessed by the user devices 260-1 to 260 is provided, e.g., by web server 205 of FIG. 2. Web server 205 comprises a processor 210 which controls the various functions and components of the server 205 via a control bus 207 as shown in FIG. 2. In addition, a server administrator may interact with and configure server 205 to run different applications using different user input/output (I/O) devices 215 (e.g., a keyboard and/or a display) as well known in the art. Server 205 also comprises a memory 225 which may represent both a transitory memory such as RAM, and a non-transitory memory such as a ROM, a hard drive and/or a flash memory, for processing and storing different files and information as necessary, including computer program products and software (e.g., as represented a flow chart diagram of by FIG. 1 to be described below), webpages, user interface information, user profiles, a plurality of user-added and/or user-selectable communication items to be described further below, metadata related to these communication items also to be described further below, electronic program listing information, databases, search engine software, and etc., as needed. A search engine and related databases may be stored in the non-transitory memory 225 of sever 205 as necessary, so that media recommendations may be made, e.g., in response to a user's profile of disinterest and/or interest in certain media assets, and/or criteria that a user specifies using textual input (e.g., queries using “sports”, “adventure”, “Tom Cruise”, and etc.).

In addition, server 205 is connected to network 250 through a communication interface 220 for communicating with other servers or web sites (not shown) and one or more user devices 260-1 to 260-n, as shown in FIG. 2. The communication interface 220 may also represent television signal modulator and RF transmitter (not shown) in the case of when the content provider 205 represents a television station, cable or satellite television provider. In addition, one skilled in the art would readily appreciate that other well-known server components, such as, e.g., power supplies, cooling fans, etc., may also be needed, but are not shown in FIG. 2 to simplify the drawing.

Returning to FIG. 1, FIG. 1 represents a flow chart diagram of an exemplary process 100 according to the present principles. Process 100 may be implemented as a computer program product comprising computer executable instructions which may be executed by e.g., processor 265 of device 260-1 and/or processor 210 of sever 205 of FIG. 2. The computer program product having the computer-executable instructions may be stored in a non-transitory computer-readable storage media as represented by e.g., memory 285 and/or memory 225 of FIG. 2. One skilled in the art can readily recognize that the exemplary process shown in FIG. 1 may also be implemented using a combination of hardware and software (e.g., a firmware implementation), and/or executed using programmable logic arrays (PLA) or application-specific integrated circuit (ASIC), etc., as already mentioned above.

At step 120 of FIG. 1, a video is displayed on a display device of a first electronic device concurrently with a second electronic device. For example, the first electronic device may be represented by Device 1 260-1 of FIG. 2, and the second electronic device may be represented by one of devices 260-2 to 260-n of FIG. 2. In addition, step 120 of FIG. 1 is also illustrated in an exemplary system 400 of FIG. 4. As shown in FIG. 4, a video 425 is being watched by a first user and displayed on a first electronic device 420 and the same video 435 is also shown as being concurrently watched by another viewer and displayed on a second electronic device 430.

At step 130 of FIG. 1, a first communication item is selected during a user interactive session by a user of the first communication device while watching the displayed video content at the first electronic device in order to provide user interaction and communication with one or more remote users concurrently watching is the shared video on their respective devices. This is also illustrated in in FIG. 3A which shows an exemplary user interface screen 300 of an exemplary apparatus in accordance with the present principles. The user interface screen 300 may be provided, e.g., by an exemplary user computing device, such as e.g., device 260-1 of FIG. 2. The user interface screen 300 may be displayed, e.g., on a display 291 and/or 292 of the device 260-1 of FIG. 2, as described above in connection with FIG. 2.

As shown in FIG. 3A, a user may enter an interactive session while watching a video content 350 by the user selecting the “interactive session” icon 305 on screen 300. The “interactive session” icon 305 may be selected using a selector 310 shown in FIG. 3A. The selector 310 may represent a selector icon which is capable of being moved by a mouse as represented by one of the user I/O devices 280 of device 260-1 of FIG. 2. Selector 310 of FIG. 3A may also represent a user's physical finger for moving and selecting icons and/or items on a touch screen 291 or 292 of device 260-1 of FIG. 2, also as described above in connection with FIG. 2.

Also shown in FIG. 3A, when the user interactive session is entered into by the user of the first device, a set of user-selectable communication items will appear in an area 320 of screen 300. According to the present principles, exemplary user-selectable communication items may be, e.g., items such as graphical items representing e.g., an emoji (e.g., one of 361-366), a sticker (e.g., 367), a text bubble (e.g., 368), and etc. As to be described in more detail later, user-entered text representing a user comment during an interactive conversation may be entered into the text bubble 368, if the text bubble 368 is selected by the user.

At step 140 of FIG. 1, a user of the first device such as that represented by e.g., device 260-1 of FIG. 2 may overlay the selected first communication item onto the video at the first electronic device during the interactive session between the first electronic device and one or more of the devices 260-2 to 260-n of FIG. 2. This is also illustrated in FIG. 3B. As shown in FIG. 3B, a user of the first electronic device as represented by e.g., device 260-1 of FIG. 2 may also move e.g., a selected communication item 363 from area 320 to another location of the screen 300 such as e.g., a new location 345 on the screen 300, via a path (as shown by a dashed arrow 340) using the selector 310. In this example, the selected item is an emoji icon 363, selected from one of the emoji icons 361-366 in area 320 as shown on screen 300 of FIG. 3B. Accordingly, the selected item 363 is moved and shown as being overlaid on top of the video content 350 at a new location 345. The overlaid selected item is now labeled as item 363′ on screen 300 of FIG. 3B.

At step 150 of FIG. 1, according to the present principles, a user of the first electronic device as represented by e.g., device 260-1 of FIG. 2 may then cause the same selected overlaid item 363′ to also be displayed on one or more of the remote devices such as e.g., devices 260-2 to 260-n shown in FIG. 2. The user of the first device may do this by selecting, e.g., a “SEND” icon 370 shown on screen 300 of FIG. 3B. Accordingly, information related to the selected first communication item such as item 363′ is provided by the first electronic device to allow the first communication item to also be properly displayed and overlaid onto the video content 350 at one or more of the second electronic devices 260-2 to 260-n shown in FIG. 2.

According to the present principles, in one exemplary embodiment, the information about the overlaid selected first communication comprises metadata on content of the overlaid selected first communication item, and location of the overlaid selected first communication item on the video. The content may be for example, an item identification number such as e.g., 363, which may be used to identify the particular emoji 363 from the plurality of pre-provided items 361-368 in area 320 of screen 300 as shown in the example of FIG. 3B. The location of the overlaid selected first communication item 363′ may be the pixel position within the video frame of the video 350 being presented. The pixel position may be, e.g., the starting pixel position of icon 363′ on screen 300.

In one exemplary embodiment, the metadata information regarding the overlaid selected first communication item 363′ are sent to the content provider such as content server 205 shown in FIG. 2. The content server then take these data and incorporate them into the next available streaming segments to be sent to one or more of the second electronic devices 260-2 to 260-n shown in FIG. 2 where a respective user is currently watching the same content 350. The content server 205 may incorporate this information into an auxiliary content stream, using, e.g., Apple's HTTP Live Streaming (HLS) protocol as to be described below.

As described previously in connection with FIG. 2, one of the many well-known streaming protocols is Apple HTTP Live Streaming (HLS) protocol. As described in HTTP Live Streaming Overview (see https://developer.apple.com), Apple HLS audio and video content may be provided from a web server. The client software may be a Safari browser or an app written for iOS or Mac OS X running on an Apple iOS device. Similar to other streaming protocols, Apple HLS sends audio and video as a series of small files or segments, typically of about 10 seconds in duration, called media segment files. An index file, or playlist, gives the clients the URLs of the media segment files. The playlist can be periodically refreshed to accommodate live broadcasts, where media segment files are constantly being updated and produced. In addition, auxiliary contents such as Closed Captions or subtitles in Apple HLS are sent as separate streams or tracks to be overlaid at the decoder. The resulting media playlist includes segment durations to sync text with the correct point in the associated video. Advanced features of live streaming subtitles and closed captions include, e.g., semantic metadata, CSS styling, and simple animation. In particular, CSS stands for Cascading Style Sheet and is used to keep information in the proper display format on a screen. CSS files can help define font, size, color, spacing, border and location of an object on a screen or a web page, and can also be used to create a continuous look throughout multiple frames of a screen or webpages.

Accordingly, in one exemplary embodiment, the information comprising metadata regarding the overlaid selected first communication item 363′ provided by the first electronic device 260-1 shown in FIG. 2 is packaged by the content provider 205 of FIG. 2 by taking advantage of the same or similar protocol and format as those used by closed caption and subtitles in Apple HLS, in order for the overlaid item to be sent to the remote devices of 260-2 to 260-n of FIG. 2. That is, for example, metadata information regarding the overlaid selected item 363′ shown in FIG. 3B are provided as an one of the auxiliary content streams for the next available segments to be downloaded at the second devices, using the type of protocol provided for e.g., Apple HLS for closed caption and subtitles, as described above.

At step 160 of FIG. 1, the first device as represented by e.g., device 260-1 of FIG. 2 may also display a second communication item which is selected, overlaid, and sent by a user of one or more of the remote devices 260-2 to 260-n of FIG. 2, while a respective remote user is watching the same content at one or more of the remote devices 260-2 to 260-n. This is shown in FIG. 3C, where a graphical item representing a sticker of a Hello Kitty 367′ has been sent by one of the 260-2 to 260-n of FIG. 2 and is being displayed by the first electronic device 260-1 of FIG. 1.

As already described above in connection with steps 120-150, the sticker 267′ is similarly selected at a second electronic device, moved and overlaid by a remote user accordingly. The corresponding metadata information representing the content and location of the selected sticker 267′ is also sent to the content server 205 of FIG. 2, and then provided in, e.g., auxiliary content streams, using the type of protocol provided by e.g., by Apple HLS for closed caption and subtitle, as described above. Accordingly, device 260-1 processes the metadata information of the second communication item 267′ from a second electronic device and displays it on screen 300 of the first electronic device 260-1, as shown on screen 300 of FIG. 3C.

In another exemplary embodiment accordance with the present principles, at step 170 and as illustrated in FIG. 3C, an object such as a chair 380 on the video 350 may be selected for linking with a selected communication item during the interactive session. For example, as shown in FIG. 3C, a user may select a text bubble 368 on screen 300 as the selected communication item during an interactive session as described in connection with steps 130 and 140 above. The user may then place and link this text bubble 368 with an object on the video.

The object may be, e.g., a person such as an actor or a thing such as a chair 380 shown in FIG. 3C. If a selected object is linkable, then the linkable object is highlighted when a selected communication item is moved in close proximity to the linkable object. This is illustrated in FIG. 3C so that when the text bubble 368 is moved close to the object, chair 385, the object is highlighted (as represented by a highlight enclosure 380). In one exemplary embodiment, the selected object such as chair 385 is identified by metadata associated with the video 350. The metadata may contain information such as, e.g., whether an object is linkable, as well as information identifying its identity, location and pixel content on the video frames which it exists in the video.

In addition, once a selected communication item such as a text bubble 368′ shown in FIG. 3C is linked to a linkable object 385 on the video 350 as shown in FIG. 3C, the linkage information is provided as part of the metadata information for linking the selected first communication item 367′ with the linked object 385 on the video 350 as part of the information provided to the content server 205. Accordingly, for example, the selected text bubble 368′ will be linked to the chair 385 on the video 350 being concurrently watched on of all of the devices, even if the chair is moved from one scene to another. Therefore, a comment provided by a user via the text bubble 368′ will stay relevant to the linked object 385 from one scene to another.

At step 180 of FIG. 1, according to an exemplary embodiment of the present principles, an overlaid selected first communication item will be displayed on the video of the display device of the first electronic device, and/or at the second electronic device for a given duration, or disappear once the other viewer has viewed or deleted it. Therefore, the overlaid item will be removed at a given time.

In accordance with the present principles, FIG. 3D shows an exemplary embodiment of how a text box 368′ may be customized by entering text representing a conversation between the viewers during an interactive session. As shown in FIG. 3D, a user may enter the text 369 by using a virtual keyboard 390 on a touch screen of a display 291 and/or 291 as described above. After the user has entered the desired text 369, the user may select the “SEND” icon 370 to send the text bubble 368′ with the customized text 369 to one or more of the user devices 260-2 to 262-n of FIG. 2.

Therefore, in accordance with the present principles, as illustrated in FIG. 4, one or more users may watch a video on one or more devices concurrently and add user-added commentary and content to provide an enhanced video sharing experience. For example, FIG. 4 shows that device 420 and device 430 are displaying the same video content 425 and 435 respectively, each with the same three overlaid items, 451-453, and 461-463 respectively.

In addition, although an exemplary embodiment has been described above mainly with a content being provided by a streaming server 205 in FIG. 2, one skilled in the art may readily recognize that, e.g., a user device 260-1 may stream its own content to be shared by other devices 260-2 to 260-n, without going through the content server 205 in FIG. 2, if the device 260-a has its own video encoding and transporting capabilities. In this scenario, the metadata information related to the overlaid selected communication items will also be transferred among the user devices 260-1 to 260-n, without going through the content provider 205 in FIG. 2. Therefore, the present principles may also provide video sharing with user-added content directly among user devices, without going through a content server or website.

While several embodiments have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present embodiments. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings herein is/are used. Those skilled in the art will recognize, or be able to ascertain using no more than routine experimentation, many equivalents to the specific embodiments described herein. It is, therefore, to be understood that the foregoing embodiments are presented by way of example only and that, within the scope of the appended claims and equivalents thereof, the embodiments disclosed may be practiced otherwise than as specifically described and claimed. The present embodiments are directed to each individual feature, system, article, material and/or method described herein. In addition, any combination of two or more such features, systems, articles, materials and/or methods, if such features, systems, articles, materials and/or methods are not mutually inconsistent, is included within the scope of the present embodiment.

1. A first electronic device for communicating with a second electronic device, the first electronic device comprising:
a display device driver configured to cause to display a video, the video also displayed via the second electronic device;
a user interface device configured to select a first communication item at the first electronic device and to overlay the selected first communication item onto the video at the first electronic device, the first item being overlaid onto the video during an interactive session between the first electronic device and the second electronic device; and
a processor configured to provide information on the overlaid selected first communication item for causing to display the first communication item overlaid onto the video via the second electronic device;
wherein the information on the overlaid selected first communication item comprises metadata on content of the overlaid selected first communication item, and wherein the user interface device is further configured to select an object on the video for linking the selected first communication item with the selected object on the video.

2. The first electronic device of claim 1 wherein the processor is further configured to cause to display a second communication item with the displayed video, wherein the second communication item is overlaid on the video by the second electronic device during the interactive session.

3. The first electronic device of claim 2 wherein the processor is further configured to remove the overlaid selected first communication item from the displayed video.

4. The first electronic device of claim 1 wherein the selected first communication item is displayed on the video at the second electronic device for a given duration.

5. The first electronic device of claim 1 wherein the first communication item is a graphical item.

6. (canceled)

7. (canceled)

8. The first electronic device of claim 1, wherein the selected object on the video is identified by metadata contained in the video.

9. The first electronic device of claim 8 wherein the metadata of the overlaid selected first communication item further comprises information for linking the selected first communication item with the selected object on the video.

10. The first electronic device of claim 5 wherein the graphical item is an emoji.

11. The first electronic device of claim 1 wherein the selected first communication item comprises text representing a conversation during the interactive session.

12. A method performed by a first electronic device for communicating with a second electronic device, the method comprising:
causing to display the video on a display device driven by the first electronic device, the video also displayed via the second electronic device;
selecting a first communication item at the first electronic device;
overlaying the selected first communication item onto the video at the first electronic device, the first item being overlaid onto the video during an interactive session between the first electronic device and the second electronic device; and
providing information on the selected first communication item for displaying the first communication item overlaid onto the video at the second electronic device;
wherein the information on the overlaid selected first communication item comprises metadata on content of the overlaid selected first communication item, and wherein the user interface device is further configured to select an object on the video for linking the selected first communication item with the selected object on the video.

13. The method of claim 12 further comprising displaying a second communication item with the video on the display device, wherein the second communication item is overlaid on the video by the second electronic device during the interactive session.

14. The method of claim 13 further comprising removing the overlaid selected first communication item from the video on the display device.

15. The method of claim 13 wherein the selected first communication item is displayed on the video at the second electronic device for a given duration.

16. The method of claim 12 wherein the first communication item is a graphical item.

17. (canceled)

18. (canceled)

19. The method of claim 12 wherein the selected object on the video is identified by metadata contained in the video.

20. The method of claim 19 wherein the metadata of the overlaid selected first communication item further comprises information for linking the selected first communication item with the selected object on the video.

21. (canceled)

22. The method of claim 12 wherein the selected first communication item comprises text representing a conversation during the interactive session.

23. A computer program product stored in non-transitory computer-readable storage media for a first electronic device for communicating with a second electronic device, the computer program product comprising computer-executable instructions for:
causing to display the video on a display device driven by the first electronic device, the video also displayed via the second electronic device;
selecting a first communication item at the first electronic device;
overlaying the selected first communication item onto the video at the first electronic device, the first item being overlaid onto the video during an interactive session between the first electronic device and the second electronic device; and
providing information on the selected first communication item for displaying the first communication item overlaid onto the video at the second electronic device.
wherein the information on the overlaid selected first communication item comprises metadata on content of the overlaid selected first communication item, and wherein the instructions provide for selection of an object on the video for linking the selected first communication item with the selected object on the video.

24. The first electronic device of claim 1 wherein the video is a streaming video selected by the first electronic device and the second electronic device.

25. The method of claim 12 wherein the video is a streaming video selected by the first electronic device and the second electronic device.
